(19) United States
(12) Patent Application Publication
(10) Pub. No.: US 2025/0117582 A1
(43) Pub. Date: Apr. 10, 2025

(54) TEXT GENERATION BY GENERALIZING SAMPLED RESPONSES

(71) Applicant: NEC Laboratories America, Inc., Princeton, NJ (US)

(72) Inventor: Christopher Malon, Fort Lee, NJ (US)

(21) Appl. No.: 18/882,877

(22) Filed: Sep. 12, 2024

Related U.S. Application Data
(60) Provisional application No. 63/543,316, filed on Oct. 10, 2023.
(60) Provisional application No. 63/598,265, filed on Nov. 13, 2023.
(60) Provisional application No. 63/609,474, filed on Dec. 13, 2023.

(51) Int. Cl. G06F 40/284; G06F 16/33; G06F 40/253; G06F 40/40

(52) U.S. Cl. CPC G06F 40/284; G06F 16/3344; G06F 40/253; G06F 40/40

(57) ABSTRACT

Methods and systems for generating text include sampling a plurality of sentences generated by a language model in response to a query. A sentence is selected from the plurality of sentences using a score that is based on token consistency between the plurality of sentences.

### RELATED APPLICATION INFORMATION

This application claims priority to U.S. Patent Application No. 63/543,316, filed on Oct. 10, 2023, to U.S. Patent Application No. 63/598,265, filed on Nov. 13, 2023, and to U.S. Patent Application No. 63/609,474, filed on Dec. 13, 2023, each incorporated herein by reference in its entirety.

### BACKGROUND

### Technical Field

The present invention relates to machine learning systems and, more particularly, to text generation models.

### Description of the Related Art

Large language models (LLMs) are machine learning models that use large volumes of textual training data to train their many parameters. LLMs can generate natural language text that can appear indistinguishable from text that is generated by a human, making them useful for automated knowledge retrieval systems. A query can be presented in natural language and the LLM can provide a response that is based on the information available in its training corpus. An LLM that is trained on domain-specific information can thereby be used as a resource for distilling useful knowledge from a large volume of information.

However, because the LLM is not actually aware of what it is outputting, it can generate well-formed, plausible outputs that are nonetheless factually incorrect. These outputs are called hallucinations. Additionally, private and personally identifying information that is part of the training corpus may leak into the LLM's output.

### SUMMARY

A method for generating text include sampling a plurality of sentences generated by a language model in response to a query. A sentence is selected from the plurality of sentences using a score that is based on token consistency between the plurality of sentences.

A system for generating text includes a hardware processor and a memory that stores a computer program. When executed by the hardware processor, the computer program causes the hardware processor to sample a plurality of sentences generated by a language model in response to a query and to select a sentence from the plurality of sentences using a score that is based on token consistency between the plurality of sentences.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram of a text generation system that suppresses hallucinations by selecting a sentence from multiple outputs based on how common its tokens are across the multiple outputs, in accordance with an embodiment of the present invention;

FIG. 2 is a block/flow diagram of a method for selecting a sentence based on how common its tokens are across multiple sentences, in accordance with an embodiment of the present invention;

FIG. 3 is a block/flow diagram of a method for text generation that suppresses hallucinations, in accordance with an embodiment of the present invention;

FIG. 4 is a block diagram of a healthcare facility that uses information retrieval with hallucination suppression, in accordance with an embodiment of the present invention;

FIG. 5 is a block diagram of a computing device that can select sentences from an output of a large language model (LLM) and can perform treatment adjustments, in accordance with an embodiment of the present invention;

FIG. 6 is a diagram of an exemplary neural network architecture that can be used to implement part of an LLM, in accordance with an embodiment of the present invention; and

FIG. 7 is a diagram of an exemplary deep neural network architecture that can be used to implement part of an LLM, in accordance with an embodiment of the present invention.

### DETAILED DESCRIPTION OF PREFERRED EMBODIMENTS

A large language model (LLM) may be used to generate text based on its training data, but may suffer from hallucinations and other undesirable artifacts. Given a prompt, the LLM may be used to generate multiple outputs. A sentence may be selected from the multiple outputs based on one or more criteria. The best generalized sentence output by the generalization may be selected and will be relatively safe as compared to the raw output of the LLM, as artifacts and hallucinations will tend to appear randomly, while the core meaning of the sentence will be relatively stable. Taking the sample with, for example, the best average token overlap will prefer hallucination-free samples which include non-arbitrary details that are found across multiple samples.

This procedure may be repeated to add additional sentences to the selected sentence, with each being conditioned on previously chosen output sentences. New sentences can be added in this way until the language model predicts end-of-output tokens or no suitable generalization is found. By conditioning on the output before the next sentence is generated, fluency and consistency can be maintained in the samples for the next sentence. Non-redundancy criteria may be imposed to prevent the output from repeating.

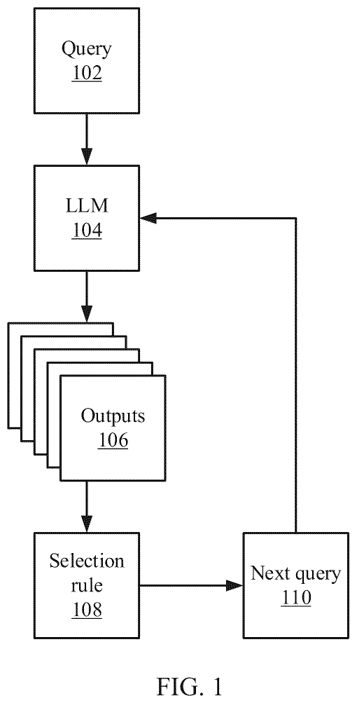

Referring now to FIG. 1, a diagram of text generation is shown. An input query 102 is provided, for example by a user, that requests information from an LLM 104 or other text-generating language model. The LLM 104 is used to generate multiple outputs 106 responsive to the query 102. These outputs 106 may include natural language statements made up of one or more sentences. While the outputs 106 may include correct information that is responsive to the query 102, they may also include incorrect information. In an example, outputs 106 may be sampled with nucleus sampling, with parameters p=0.9 and n=5. Thus, five outputs may be sampled until a full sentence is completed in each.

While the correct information will tend to be consistent between the outputs 106, the hallucinations will tend to be more variable. A selection rule 108 is therefore used to select a sentence from the outputs that is likely to exclude hallucinations. For example, the first sentence of each of the outputs 106 may be considered, and one of these first sentences may be selected. The selected sentence (and any prior selected sentences) are used to form a next query 110 to the LLM 104 to generate a new set of outputs 106. The new outputs will be conditioned on the previously selected sentence(s) to create a final output that is coherent.

This process continues until some stopping criterion is reached. For example, if a stopping token is generated or if there is no new, non-redundant information generated by the LLM 104, then the previously selected sentences may be output as a final response that has a lower incidence of hallucination than would the raw outputs of the LLM 104. Thus, generation may stop when any of the outputs 106 ends after the current sentence.

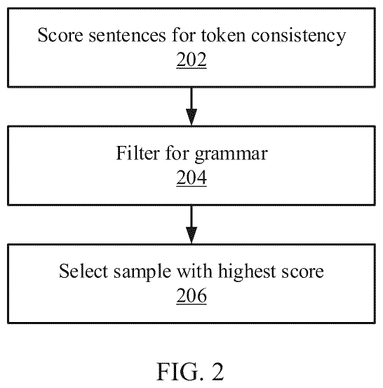

Referring now to FIG. 2, a method of selecting a sentence is shown. Block 202 scores each of the sampled sentences for token consistency. This includes, for each sampled sentence, counting the number of other sampled sentences that match each token of the sampled sentence. The score can then be calculated as the average count per token. If the n sampled sentences s₁, . . . , sₙ, include words wᵢ^{j}, with j=1, . . . , mᵢ, then the score of the sample sentence i is:

$$\frac{1}{{m}_{i}} {\sum }_{j = 1}^{{m}_{i}} {\sum }_{k = 1}^{n} {1}_{{w}_{i}^{j} ∈ {s}_{k}}$$

where mᵢ is the number of words in the sentence sᵢ and where 1 wᵢ^{j}∈sₖ is 1 if the token wᵢ^{j} is in sentence sₖ and is 0 otherwise. This score captures the idea that trustworthy details will reoccur frequently across outputs, while incorrect details will tend not to be repeated.

Block 204 filters the outputs for grammaticality, for example ensuring that the samples include a subject and a verb, by computing parts of speech and dependency parsing, and comparing to a set of designated tags. The goal of grammar checking is to reject incomplete sentence fragments that may be output by the LLM 104. Any samples that fail the grammaticality check may have their scores reset to zero. If there are no grammatical samples, then generation of text may be aborted. Block 206 then selects the remaining sample with the highest score.

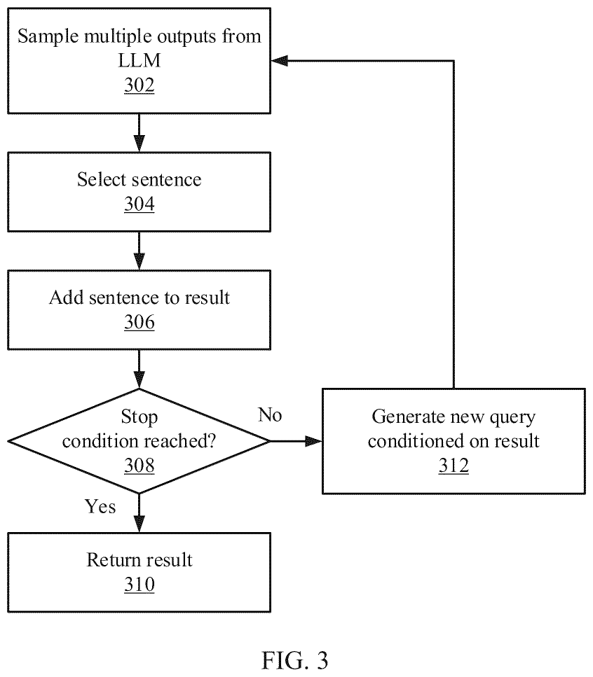

Referring now to FIG. 3, a method of generating text is shown. Block 302 samples multiple outputs from LLM 104 using an input query 102. Any appropriate number of outputs may be generated, with block 302 taking the first sentence of each. Block 304 then selects a sentence from the multiple outputs, for example in accordance with a score as described above with reference to FIG. 2. This selected sentence is added to a running result, which starts empty and which is added to with each iteration.

Block 308 then determines whether a stop condition has been reached. Example stop conditions include determining whether the LLM 104 has indicated a stop to one of the outputs, whether all the outputs failed the grammar check, whether all scores are too low, whether a maximum result length has been reached, or any other appropriate condition. If the stop condition has been reached, block 310 returns the result that includes all of the selected sentences.

If no stop condition has been reached, then block 312 generates a new query that is conditioned on the running result. For example, the new query may include the original query and may provide the running result as a condition for the next tokens. The new query is then input to the LLM 104 and new sentences are sampled. This process may be repeated iteratively to build a full result, with the most recent selected sentence being added to the running result until a stop condition is reached.

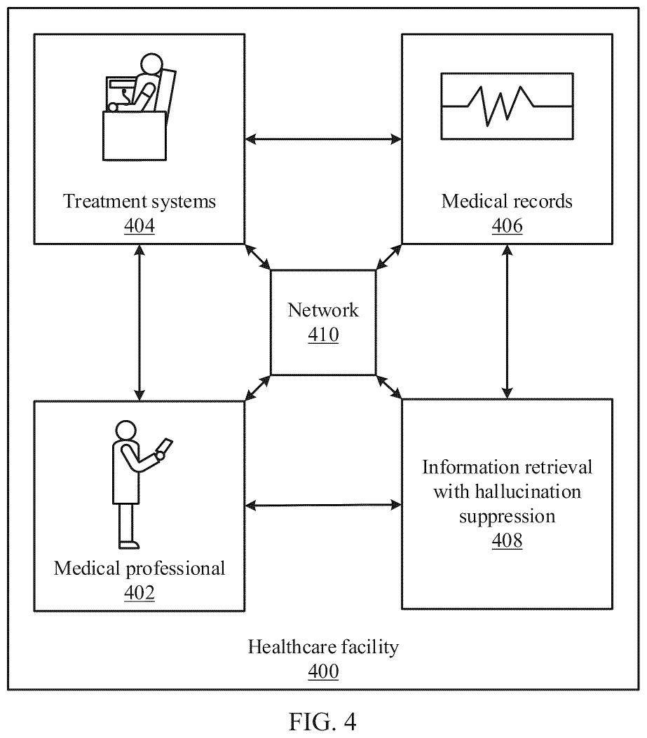

Referring now to FIG. 4, a diagram of information extraction is shown in the context of a healthcare facility 400. Information retrieval with hallucination suppression 408 may be used to generate predictions about a patient's condition and treatment. For example, information relating to the patient's present and previous medical state may be provided as the medical records 406, and the output of the information retrieval with hallucination suppression 408 can be used to guide medical decision making.

The healthcare facility 400 may include one or more medical professionals 402 who review information extracted from a patient's medical records 406 to determine their healthcare and treatment needs. These medical records 406 may include self-reported information from the patient, test results, and notes by healthcare personnel made to the patient's file. Treatment systems 404 may furthermore monitor patient status to generate medical records 406 and may be designed to automatically administer and adjust treatments as needed.

Based on information drawn from the information retrieval with hallucination suppression 408, the medical professionals 402 may then make medical decisions about patient healthcare suited to the patient's needs. For example, the medical professionals 402 may make a diagnosis of the patient's health condition and may prescribe particular medications, surgeries, and/or therapies.

The different elements of the healthcare facility 400 may communicate with one another via a network 410, for example using any appropriate wired or wireless communications protocol and medium. Thus information retrieval with hallucination suppression 408 obtains information about a patient and updates the medical records 406 with its output. In some cases, the results of the information retrieval with hallucination suppression 408 may be used to coordinate with treatment systems 404 to automatically administer or alter a treatment. For example, if the information retrieval with hallucination suppression 408 indicates a dangerous condition, then the treatment systems 404 may automatically halt the administration of the treatment.

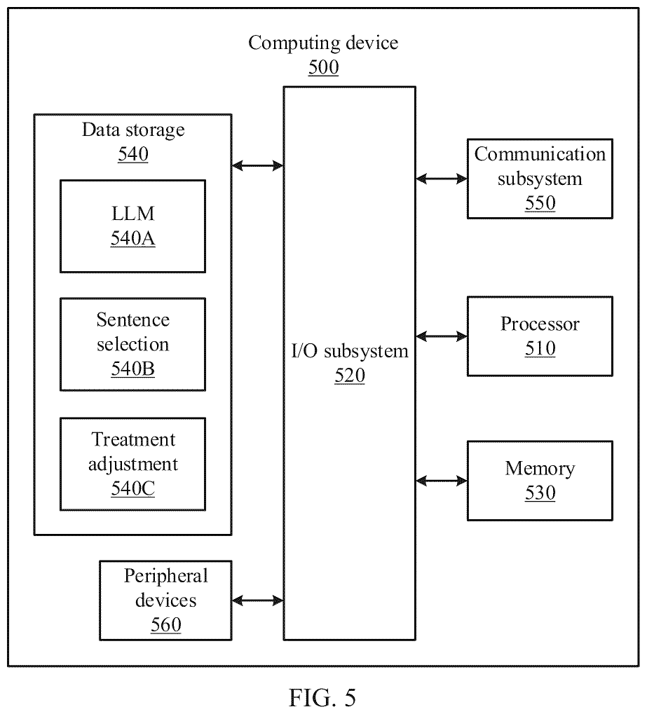

As shown in FIG. 5, the computing device 500 illustratively includes the processor 510, an input/output subsystem 520, a memory 530, a data storage device 540, and a communication subsystem 550, and/or other components and devices commonly found in a server or similar computing device. The computing device 500 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 530, or portions thereof, may be incorporated in the processor 510 in some embodiments.

The processor 510 may be embodied as any type of processor capable of performing the functions described herein. The processor 510 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 530 may be embodied as any type of volatile or non-volatile memory or data storage capable of performing the functions described herein. In operation, the memory 530 may store various data and software used during operation of the computing device 500, such as operating systems, applications, programs, libraries, and drivers. The memory 530 is communicatively coupled to the processor 510 via the I/O subsystem 520, which may be embodied as circuitry and/or components to facilitate input/output operations with the processor 510, the memory 530, and other components of the computing device 500. For example, the I/O subsystem 520 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 520 may form a portion of a system-on-a-chip (SOC) and be incorporated, along with the processor 510, the memory 530, and other components of the computing device 500, on a single integrated circuit chip.

The data storage device 540 may be embodied as any type of device or devices configured for short-term or long-term storage of data such as, for example, memory devices and circuits, memory cards, hard disk drives, solid state drives, or other data storage devices. The data storage device 540 can store program code 540A for an LLM, 540B for selecting sentences from the LLM that are consistent, and/or 540C for adjusting treatment based on the LLM's output. Any or all of these program code blocks may be included in a given computing system. The communication subsystem 550 of the computing device 500 may be embodied as any network interface controller or other communication circuit, device, or collection thereof, capable of enabling communications between the computing device 500 and other remote devices over a network. The communication subsystem 550 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 500 may also include one or more peripheral devices 560. The peripheral devices 560 may include any number of additional input/output devices, interface devices, and/or other peripheral devices. For example, in some embodiments, the peripheral devices 560 may include a display, touch screen, graphics circuitry, keyboard, mouse, speaker system, microphone, network interface, and/or other input/output devices, interface devices, and/or peripheral devices.

Of course, the computing device 500 may also include other elements (not shown), as readily contemplated by one of skill in the art, as well as omit certain elements. For example, various other sensors, input devices, and/or output devices can be included in computing device 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

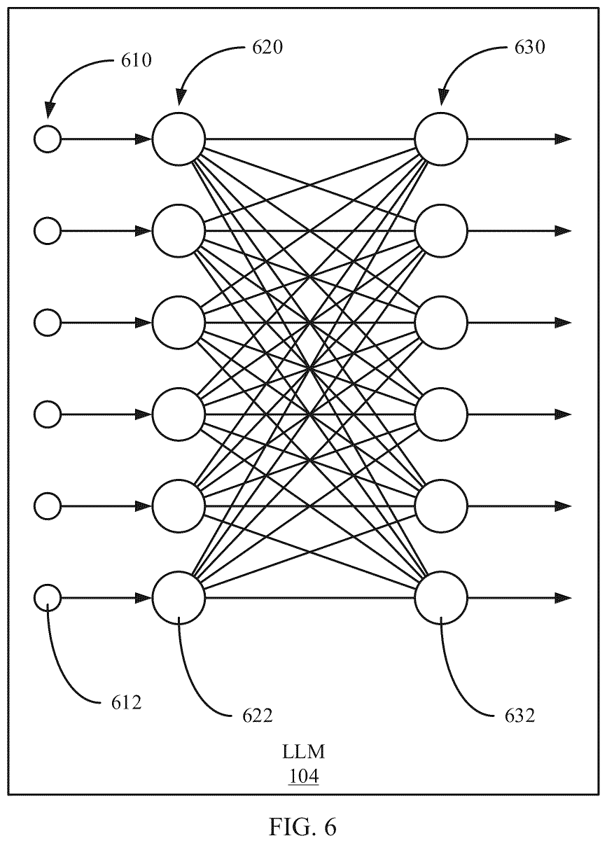

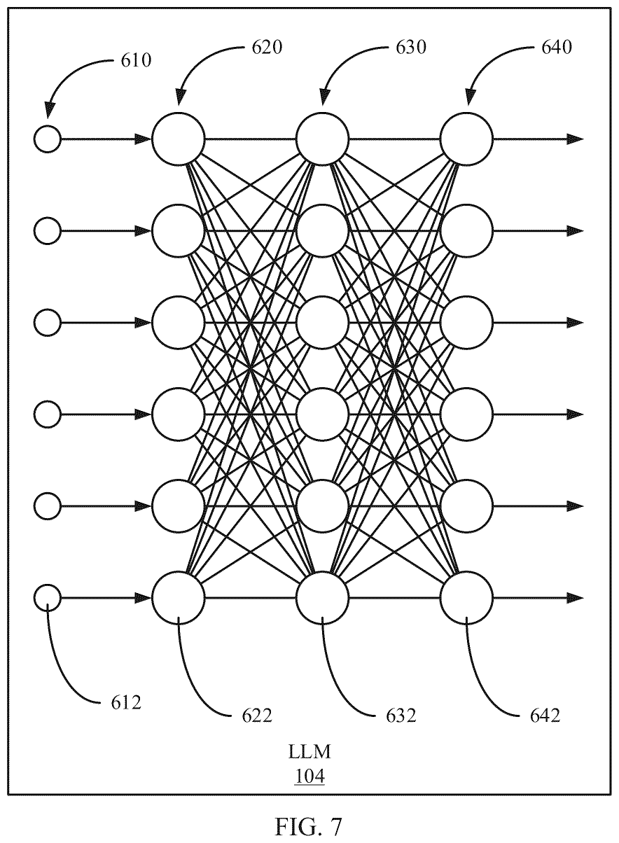

Referring now to FIGS. 6 and 7, exemplary neural network architectures are shown, which may be used to implement parts of the present models, such as the LLM 104. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 620 of source nodes 622, and a single computation layer 630 having one or more computation nodes 632 that also act as output nodes, where there is a single computation node 632 for each possible category into which the input example could be classified. An input layer 620 can have a number of source nodes 622 equal to the number of data values 612 in the input data 610. The data values 612 in the input data 610 can be represented as a column vector. Each computation node 632 in the computation layer 630 generates a linear combination of weighted values from the input data 610 fed into input nodes 620, and applies a non-linear activation function that is differentiable to the sum. The exemplary simple neural network can perform classification on linearly separable examples (e.g., patterns).

A deep neural network, such as a multilayer perceptron, can have an input layer 620 of source nodes 622, one or more computation layer(s) 630 having one or more computation nodes 632, and an output layer 640, where there is a single output node 642 for each possible category into which the input example could be classified. An input layer 620 can have a number of source nodes 622 equal to the number of data values 612 in the input data 610. The computation nodes 632 in the computation layer(s) 630 can also be referred to as hidden layers, because they are between the source nodes 622 and output node(s) 642 and are not directly observed. Each node 632, 642 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 632 in the one or more computation (hidden) layer(s) 630 perform a nonlinear transformation on the input data 612 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for generating text, comprising:
sampling a plurality of sentences generated by a language model in response to a query; and
selecting a sentence from the plurality of sentences using a score that is based on token consistency between the plurality of sentences.

2. The method of claim 1, wherein the score for a first sentence of the plurality of sentences is measured as a count of other sentences in the plurality of sentences that share each token of the first sentence.

3. The method of claim 2, wherein the score is measured as:
$$\frac{1}{{m}_{i}} {\sum }_{j = 1}^{{m}_{i}} {\sum }_{k = 1}^{n} {1}_{{w}_{i}^{j} ∈ {s}_{k}}$$
where mᵢ is a number of words in the sentence sᵢ, n is the number of the plurality of sentences, and where is
$${1}_{{w}_{i}^{j} ∈ {s}_{k}}$$
if a token wᵢ^{j} is in sentence sₖ and is 0 otherwise.

4. The method of claim 1, further comprising filtering the plurality of sentences in accordance with a grammaticality check.

5. The method of claim 1, further comprising sampling a second plurality of sentences generated by the language model in response to a new query that includes the selected sentence and selecting a new sentence from the second plurality of sentences.

6. The method of claim 5, further comprising iteratively repeating the selecting and sampling, with new query being updated at each iteration to include a most recent selected sentence.

7. The method of claim 6, further comprising halting repetition of the selecting and sampling responsive to the language model indicating an end of output for at least one of the second plurality of sentences.

8. The method of claim 1, further comprising generating a result based on the selected sentence to aid in medical decision making while suppressing language model hallucination.

9. The method of claim 1, further comprising performing a treatment action responsive to the selected sentence, including automatically altering a patient's treatment.

10. The method of claim 9, wherein the query includes information relating to a medical condition of the patient.

11. The method of claim 2, wherein the language model is a pre-trained machine learning model that processes natural language inputs.

12. A system for generating text, comprising:
a hardware processor; and
a memory that stores a computer program which, when executed by the hardware processor, causes the hardware processor to:
sample a plurality of sentences generated by a language model in response to a query; and
select a sentence from the plurality of sentences using a score that is based on token consistency between the plurality of sentences.

13. The system of claim 12, wherein the score for a first sentence of the plurality of sentences is measured as a count of other sentences in the plurality of sentences that share each token of the first sentence.

14. The system of claim 13, wherein the score is measured as:
$$\frac{1}{{m}_{i}} {\sum }_{j = 1}^{{m}_{i}} {\sum }_{k = 1}^{n} {1}_{{w}_{i}^{j} ∈ {s}_{k}}$$
where mᵢ is a number of words in the sentence Sᵢ, n is the number of the plurality of sentences, and where
$${1}_{{w}_{i}^{j} ∈ {s}_{k}}$$
is 1 if a token wᵢ^{j} is in sentence sₖ and is 0 otherwise.

15. The system of claim 12, further comprising filtering the plurality of sentences in accordance with a grammaticality check.

16. The system of claim 12, further comprising sampling a second plurality of sentences generated by the language model in response to a new query that includes the selected sentence and selecting a new sentence from the second plurality of sentences.

17. The system of claim 16, further comprising iteratively repeating the selecting and sampling, with new query being updated at each iteration to include a most recent selected sentence.

18. The system of claim 17, further comprising halting repetition of the selecting and sampling responsive to the language model indicating an end of output for at least one of the second plurality of sentences.

19. The system of claim 12, further comprising generating a result using the selected sentence to aid in medical decision making while suppressing language model hallucination.

20. The system of claim 12, further comprising performing a treatment action responsive to the selected sentence, including automatically altering a patient's treatment.
